(19) United States
(12) Patent Application Publication
(10) Pub. No.: US 2015/0042291 A1
(43) Pub. Date: Feb. 12, 2015

(54) Method and System for Communication with a Battery Charger

(71) Applicant: INSTAVOLT INC., Blainville (CA)

(72) Inventors: Mathieu RACINE, Sainte-Therese (CA); Hossein SAMIMI, Laval (CA); Ronald GILMAN, Montreal (CA)

(73) Assignee: INSTAVOLT INC., Blainville (CA)

(21) Appl. No.: 14/455,026

(22) Filed: Aug. 8, 2014

Related U.S. Application Data
(60) Provisional application No. 61/863,767, filed on Aug. 8, 2013.

(51) Int. Cl. H02J 7/00

(52) U.S. Cl. CPC H02J 7/007; H02J 7/0047; H02J 7/0052; H02J 2007/0096
USPC 320/137

(57) ABSTRACT

A system and method for communicating with a battery charging assembly at an external communication device across a communication network. The method and system comprises: receiving status information relating to the battery charging assembly at the communication device. In response to the status information, the method comprises generating an input indicating a request for controlling operation of the battery charging assembly and comprising control parameters associated with controlling said operation. The method further comprises providing the input to the battery charging assembly for subsequently affecting operation of the battery charging assembly in accordance with the generated input.

### CROSS-REFERENCE TO RELATED APPLICATIONS

This application claims priority from U.S. Provisional Patent Application No. 61/863,767 filed on Aug. 8, 2013, the entire contents of which is incorporated herein by reference.

### FIELD

The present invention relates to a method and system for communications between a battery charger and at least one communications device. In particular, the method and system relates to the communication of battery related information and/or information relating to the status of the charger assembly to one or more external communication devices.

### BACKGROUND

A system for the charging of dry cell batteries has been previously conceived; and has been in practice. Traditional chargers input power and provide circuitry for re-charging batteries in order to make them useable again. Rechargeable batteries have been used for a number of applications, such as for automotive, consumer devices, power tools, portable machinery, and power supplies. Recently, there have been additional applications for rechargeable batteries including electric hybrid vehicles. These chargers traditionally employ a system for checking the charged state of the batteries. Typically, minimal information is displayed in a charger display such as an LED to indicate that the charger is on or off and when the charge is complete. There exists a need to be able to monitor and communicate information from these chargers to other communication devices.

### SUMMARY OF THE INVENTION

There is provided a method and system herein to address the shortcomings of current chargers and to allow for communication of battery related information for processing, monitoring, and/or display.

In one aspect of the present invention, there is provided a method for communicating with a battery charging assembly at an external communication device across a communication network, the method comprising: receiving status information relating to the battery charging assembly at the communication device; receiving an input at the communication device in response to the status information, the input indicating a request for controlling operation of the battery charging assembly and comprising control parameters associated with controlling said operation; providing the input to the battery charging assembly for subsequently affecting operation of the battery charging assembly in accordance with the input.

In yet another aspect, the method further comprises displaying the status information on a display of the communication device, the status information visually indicating a level of charge for each battery in the charging assembly with respect to at least one pre-defined threshold level (e.g. voltage level).

In yet another aspect, the method further comprises generating the input in dependence upon receiving input at a user interface of the communication device in response to the status information. In yet another aspect, the input comprises one of: a request for starting or stopping a charging of at least one battery in the battery charging assembly for subsequent implementation at a control unit of the battery charging assembly coupled to said at least one battery.

In yet another aspect, there is provided a method for communicating between a battery charging assembly and an external communication device across a communication network, the method comprising: detecting a charge status of at least one battery charging in the battery charging assembly, the charge status indicating a level of charge of the at least one battery; and providing status information indicating the charge status of the at least one battery from the battery charging assembly to the external communication device, wherein providing the status information comprises masking the status information within connection information broadcast from the battery charging assembly to the external communication device.

In yet a further aspect, the connection information comprises Bluetooth connectivity information.

In yet a further aspect, the method further comprises displaying the status information on an LCD display of the battery charging assembly, wherein the status information displays the level of charge of the at least one battery with a plurality of indicator bars, each indicator bar corresponding to a voltage threshold level, each indicator bar for visually displaying when a corresponding voltage threshold is met.

In yet a further aspect, communicating between the battery charging assembly and the external communication device comprises using one of Bluetooth and Wi-Fi communication.

In yet a further aspect, the external communication device communicates with the battery charging assembly via Bluetooth and further comprising displaying the status information for separately providing the charge status indicating a level of charge for each battery on the external communication device within Bluetooth discovery parameters associated with discovering and identifying the battery charging assembly.

In yet another aspect, the status information displayed on the external communication device comprises at least one of: health information related to each battery of the charging assembly; health monitoring information for charging circuitry of the charging assembly; alerts indicating tampering during charging activity of the charging assembly; and charging assembly operational status.

In yet another aspect, the method further comprises receiving updated status information from the battery charging assembly for display at the external communication device, the updated status information indicating the operation of the charging assembly subsequent to implement the control parameters on the charging assembly.

In yet a further aspect, the control parameters comprise a request for at least one of: starting or stopping charging of the at least one battery in the charging assembly; and, starting or stopping charging of the charging assembly, the request for subsequent implementation and acknowledgement from the charging assembly.

In yet a further aspect, the display comprises an LCD display for visually displaying a plurality of bars, each bar indicating that a pre-defined threshold voltage is met by an associated battery being charged.

In yet a further aspect, the input indicating the request for controlling operation of the battery charging assembly further comprises a request for receiving a status update relating to one or more batteries associated with the battery charging assembly.

In yet another aspect, the battery charging assembly broadcasts charge status information indicating charge levels for associated batteries being charged to associated communication devices via Bluetooth identification mechanism, the Bluetooth identification mechanism identifying the battery charging assembly and associated charge status information.

In yet another aspect, there is provided a method for communicating with a battery charging assembly at an external communication device across a communication network, the method comprising: receiving status information relating to the battery charging assembly at the communication device; generating an input at the communication device in response to the status information, the input indicating a request for controlling operation of the battery charging assembly and comprising control parameters associated with controlling said operation; providing the input to the battery charging assembly for subsequently affecting operation of the battery charging assembly in accordance with the input.

In yet another aspect, generating an input further comprises: processing the status information at the external communication device; comparing status information to pre-defined threshold values for the status information defined for the battery charging assembly; generating the input at the communication device in response to the comparison, the input for controlling operation of the battery charging assembly according to said pre-defined threshold values.

In yet another aspect, generating the input comprises comparing at least one of: charge levels for each associated battery; health information values for the battery charger assembly; tampering alert values for the battery charger assembly to at least one of: pre-defined threshold values and health information values for the battery charger assembly and respective batteries.

### BRIEF DESCRIPTION OF DRAWINGS

FIG. 1 illustrates an exemplary communication system network configured for facilitating communication between a charger assembly and one or more communication devices;

FIG. 2 illustrates an exemplary embodiment of the charger assembly and its connectivity to communication devices for use within the communication system of FIG. 1 in accordance with one embodiment;

FIG. 3 illustrates exemplary modules used for monitoring and controlling the charger assembly for use within the communication system of FIG. 1 in accordance with one embodiment;

FIGS. 4a and 4b illustrate flowcharts for an exemplary embodiment of processing used by the system and modules for monitoring and controls on the charger assembly, and the communication device for use within the communication system of FIG. 1 in accordance with one embodiment;

FIG. 5 illustrates a block diagram of an exemplary communication device for use within the communication system of FIG. 1 in accordance with one embodiment;

FIGS. 6a and 6b illustrate an exemplary embodiment of displaying battery information in the form of a display for battery charge status for use within the charger assembly of FIGS. 1 and 2 in accordance with one embodiment;

FIG. 7 illustrates a flowchart for an exemplary process for providing the power supply to the charging circuitry and the microprocessor of the charger assembly separately, in accordance with one embodiment; and

FIG. 8 illustrates an exemplary embodiment of the communications device of FIG. 1 using Bluetooth discovery to display the battery charge status.

### DETAILED DESCRIPTION

The present invention relates to a method and system for communications between a battery charger and at least one communications device (e.g. across a wireless network). In particular, the method and system relates to the communication of battery related information and/or information relating to the status of the charger assembly to one or more communication device, separate from the charger.

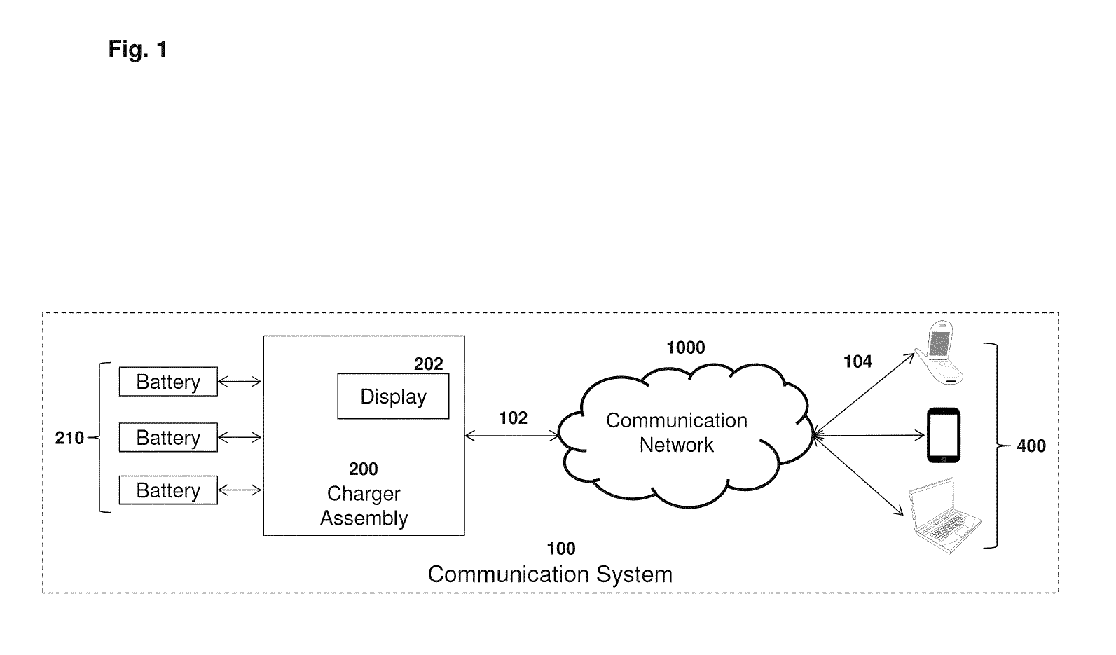

FIG. 1 illustrates an exemplary communications system 100 according to one embodiment of the invention. The system 100 comprises at least one battery 210 electronically coupled to a charger assembly 200. It is envisaged that the batteries can be chargeable or non-rechargeable batteries. Common rechargeable battery 210 types include NiCd, NiMH, lithium-ion, lithium ion polymer, lithium sulphur, Thin Film battery, Smart Batteries, Carbon foam-based lead acidic battery, Potassium ion battery, and sodium ion battery. FIG. 1 depicts three batteries as an example; this number can be increased or reduced based on the design of the charger assembly 200. The charger assembly 200 is used to charge the batteries 210 and the display 202 is used to display battery information, such as the state of the charge in one exemplary embodiment. In other embodiments, the display 202 may not be present; such as when the information related to the charger assembly 200 and or batteries 210 is communicated elsewhere or to one or more communication devices 400.

The charger assembly 200 communicates with one or more communication devices 400 via a communication network 1000. This communication can be unidirectional or bidirectional as described below. The charger assembly 200 communicates with one or more communication devices 400 by sending packets of information related to the batteries 210 and/or information relating to the charger assembly 200 (e.g. data packets 102) across a communications network 1000. In one exemplary embodiment, the communication network 1000 can be a wireless network, and utilizes wireless communication technology such as Bluetooth, Wi-Fi, Radio Frequencies, and other such technologies as envisaged by a person skilled in the art. A particular communications device 400 communicates with the charger assembly 200 by sending the response packets 104 across the communication network 1000. Examples of information carried by the packets 102 and 104 are included below.

Exemplary information for data packets 102 related to batteries 210 and/or information relating to the charger assembly 200, can include but not limited to:
Type of batteries 210 and/or charger assembly 200 (i.e. simple charger, fast charger etc.)
Number of batteries 210 being charged
Health monitoring of batteries 210 (i.e. if one is not responding or charging properly)
Alerts for any battery 210 defects (i.e. improper type of batteries inserted to charge)
Tampering alerts for batteries 210 (their unexpected/unsafe removal)
Information on damage of batteries 210 (i.e. damage from cell reversal or errors during charging process)
Whether charger assembly 200 and the charging circuitry 208 are on/off
Level of charge for the batteries being charged
Health monitoring of the charge circuitry and its components
Surges in power of charging circuitry 208
Unexpected drops in voltage and/or current supply

Exemplary response packets 104 from one or more communication devices 400, can include but not limited to:
Start or stop the charge of a particular charger assembly 200
Start or stop charge of individual batteries 210
Set predetermined time for charging to start or stop
Display alerts/errors noticed by the communication device 400
General control information for controlling the operation of the charger assembly 200 and the charging process
General inquiries regarding the health states, charge status of batteries 210 and/or charger assembly 200

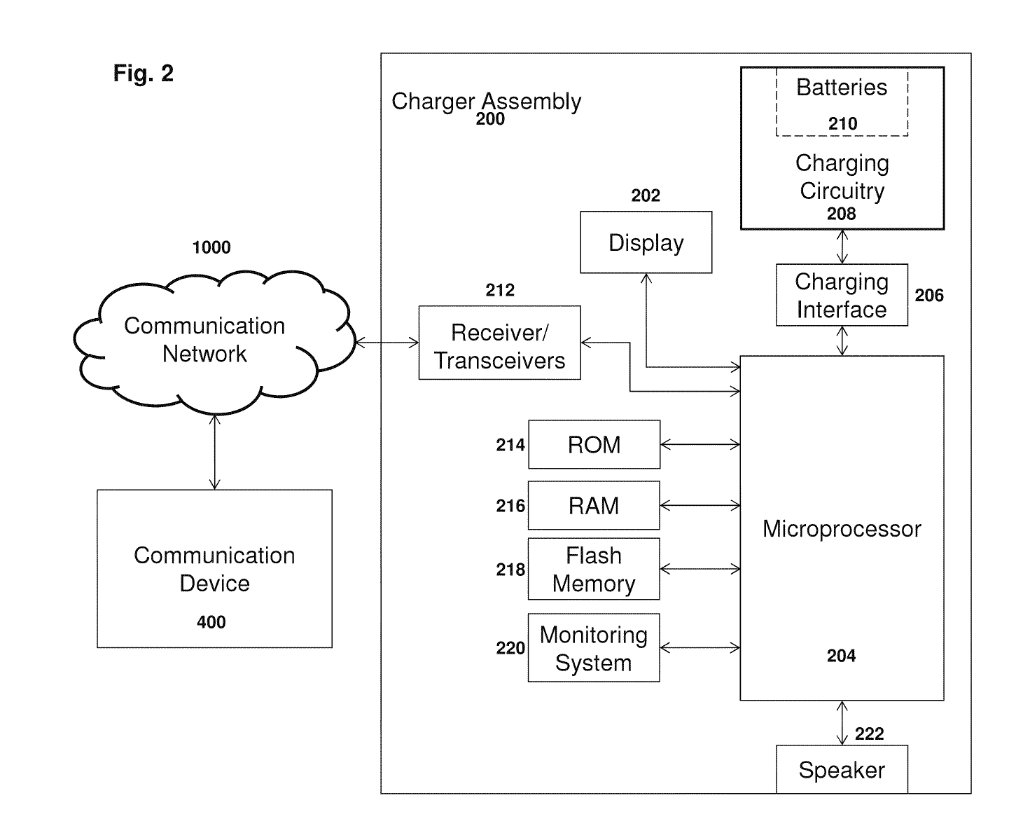

FIG. 2 describes an exemplary block diagram of a charger assembly 200 according to one embodiment of the invention. The charger assembly 200 is configured to communicate information (e.g. data packets 102) related to batteries 210 and/or information relating to the charger assembly 200 across the communication network 1000 to one or more communication devices 400. The charger assembly 200 is comprised of a number of modules (e.g. software and/or hardware) as described below.

In one exemplary embodiment, charger assembly 200 comprises of a display 202 which is used to display information related to the batteries 210 and/or information relating to the charger assembly 200 (e.g. data packets 102). In one exemplary embodiment the display 202 is an LCD display. A microprocessor 204 is used to enable the execution of various modules (e.g. monitoring system 220 and its comprising modules). It enables the processing of signals and control operations for the charger assembly 200 and its components. The microprocessor 204 is connected to a charging interface 206. The microprocessor 204 is able to communicate information on the status of each of the batteries 210 being charged by the charging circuitry 208 through the charging interface 206. For example, the charging interface 206 allows for the microprocessor to measure voltages of the batteries 210 under charge and aid in regulating the charging circuitry 208 to ensure the batteries 210 are being supplied with the necessary voltage. The charging interface 206 also aids in regulating the charging circuitry 208 in the exemplary conditions where the batteries 210 are sufficiently charged or there is potential for tampering or any other unsafe conditions with the charger assembly 200 or any of its components.

In the embodiment of the charger assembly 200 shown in FIG. 2, it comprises of a receiver/transceiver 212. The receiver/transceiver 212 allows for the transfer of data between the microprocessor 204 of the charger assembly 200, and the communication network 1000. The charger assembly 200 comprises of exemplary memory components such as ROM 210, RAM 212 and Flash memory 214 for storing data that is used by the microprocessor 204 and/or the monitoring system 220 and its underlying modules. A monitoring system 220 enables the microprocessor 204 to process the status of the charger assembly 200 batteries 210, and to communicate any alerts (i.e. tampering or other hazardous conditions). The monitoring system 220 may also allow for processing updates and controls for the charger assembly 200 its components, and batteries 210. The charger assembly 200 further comprises of a speaker 222 in an exemplary embodiment. The speaker 222 can be used for audio communication of the status or any alerts for the charger assembly 200, its components, and batteries 210.

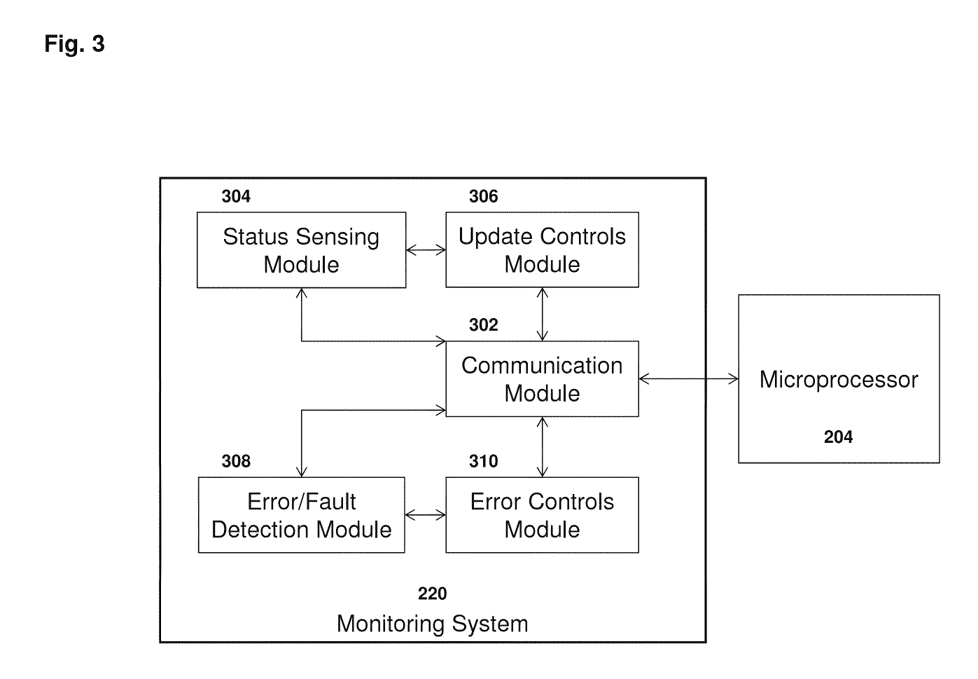

FIG. 3 illustrates a block diagram of exemplary modules which comprise the monitoring system 220. The exemplary modules which comprise the monitoring system 220 can be hardware and/or software. A communication module 302 is used for communicating information and controls between the microprocessor 204 and the monitoring system 220. A status sensing module 304 is configured to read the status of the charger assembly 200 by using information communicated through the communications module 302. The status sensing module 304 is configured to sense if the charger assembly 200 (shown in FIG. 2) is on or off, and sense the state of the charging circuitry 208. The status sensing module 304 is also capable of reading the state/level of the charge for the batteries 210 (shown in FIG. 2) under charge (e.g. checking charge in terminal voltage, temperature of a battery 210). An update controls module 306 is configured to use information received from the status sensing module 304 to develop and initiate controls for the charger assembly 200 (shown in FIG. 2) and its components. The controls initiated by the update controls module 306 are communicated through the communications module 302 to the microprocessor 200.

An error/fault detection module 308 is able to detect errors/faults with the charger assembly 200 (shown in FIG. 2) including potential disconnections or tampering in the charging circuitry 208. Exemplary capabilities also comprise the ability to sense any tampering or error with charger assembly 200 (shown in FIG. 2) and its components by using information communicated through the communications module 302. An error controls module 310 is able to use information received from the error/fault detection module 308 to develop and initiate controls for the charger assembly 200(shown in FIG. 2) and its components. The controls initiated by the error controls module 310 are communicated through the communications module 302 to the microprocessor 204.

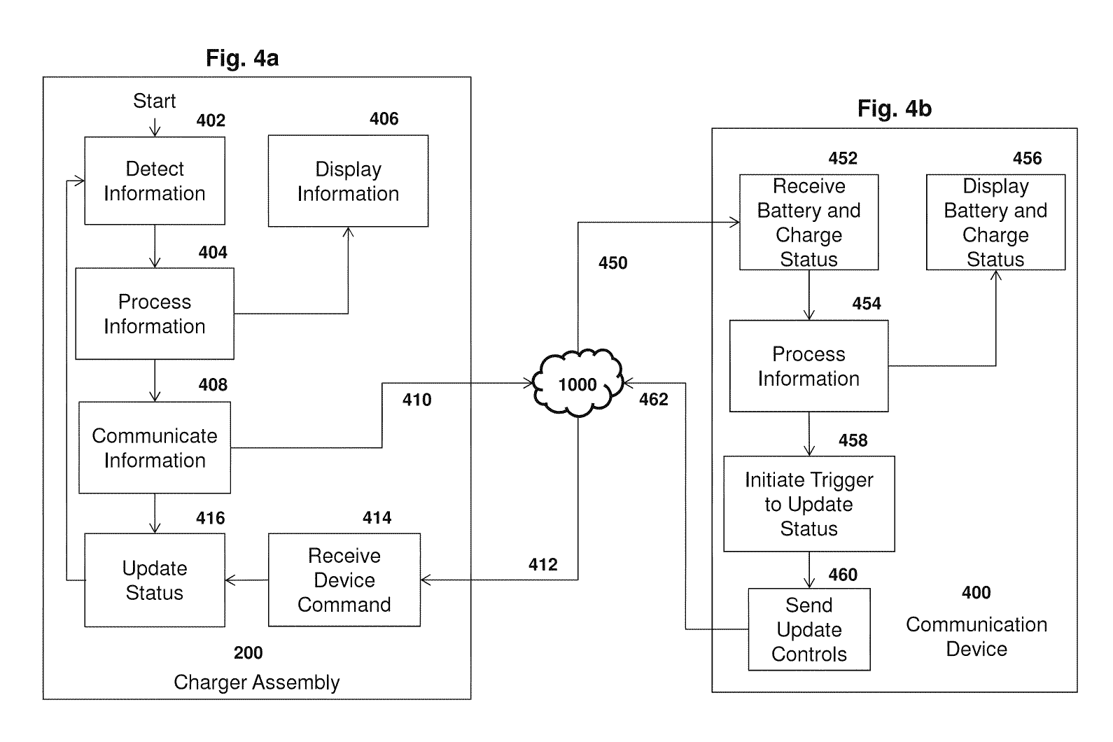

FIG. 4a illustrates an exemplary flowchart of processes that comprise the functions of the charger assembly 200 as per one embodiment. The process starts with a detection of information related to batteries 210 (shown in FIG. 2) and/or information relating to the charger assembly 200 as shown at step 402. The detection of information may be associated with one or more sensors that detect voltage levels, temperature readings of each of the batteries 210. Other sensors may be present within the charger assembly 200 for detecting tampering (e.g. opening of the charger assembly 200) or improper placement of the batteries 210. Further sensors may be used in charger assembly 200 for sensing other health related issues with the batteries such as when a battery is defective or overcharged.

At step 404 the information (e.g. the sensor information related to the batteries 210 and/or the charger circuitry) is processed. Exemplary processes comprise measuring the level of charge of batteries 210 (shown in FIG. 2) and the status of the charger assembly 200. In exemplary embodiments, the information related to batteries 210 (shown in FIG. 2) and/or information relating to the charger assembly 200 is displayed using a display at step 406. At step 408, the information related to batteries 210 (shown in FIG. 2) and/or information relating to the charger assembly 200 is communicated as an outgoing signal at step 410 to the communication device 400 through the communication network 1000. An incoming signal at step 412 from the communications device 400 is sent to the charger assembly 200 via the communications network 1000. The signal is received at step 414 and at step 416 the status of the charger assembly 200 and its components are updated according to any controls communicated in the signal at step 412. In the exemplary embodiment shown, updates to the status of the charger assembly 200 and its components can also be made at step 416 based on information communicated at step 408.

FIG. 4b illustrates an exemplary flowchart of processes that comprise the functions of one or more communication device 400 as per one embodiment. An incoming signal at step 450, comprising of information related to the batteries 210 (shown in FIG. 2) and/or information relating to the charger assembly 200 (e.g. data packets 102 shown in FIG. 1) from the charger assembly 200 is communicated across the communications network 1000 and is received at step 452. The information is processed at step 454 and in exemplary embodiments is displayed at step 456 on one or more communication devices 400. Triggers to update the status of the charger assembly 200 and its components are initiated at step 458 and communicated at step 460 as outgoing signals at step 462 (e.g. response packets 104 as shown in FIG. 1) communicated across the communications network 1000 to the charger assembly 200.

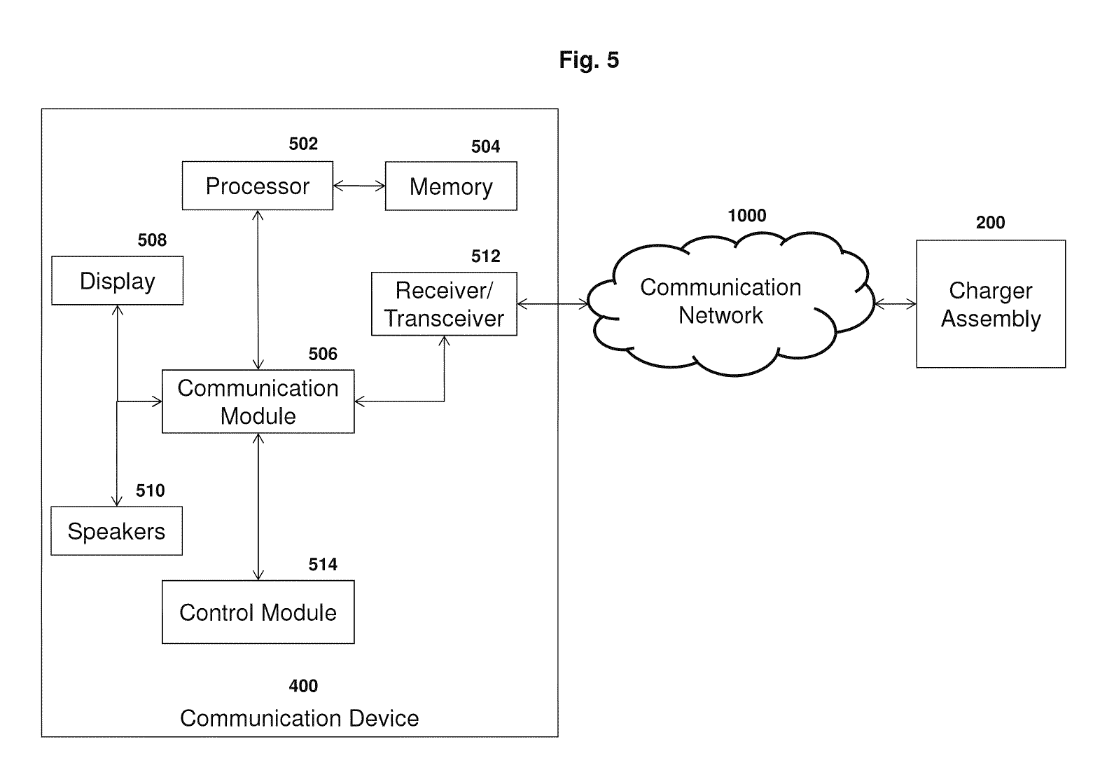

FIG. 5 illustrates a block diagram of components that comprise a communication device 400 as per one embodiment. The communication device 400 comprises of a processor 502, memory 504, communication module 506, display 508, speakers 510, and control module 514. Operating system software and other software used by a processor 502 of communication device 400 may be stored in the memory 504. The processor 502 enables execution of software applications as well operating system functions on the communication device 400. The processor 502 can communicate with other components of the communication device 400 through the communication module 506. A display 508 is configured to display information related to the batteries 210 and/or information relating to the charger assembly 200 (e.g. data packets 102 shown in FIG. 1). A speaker 510 is configured to present audio signals on information related to the batteries 210 and/or information relating to the charger assembly 200 (e.g. data packets 102 shown in FIG. 1). A receiver/transceiver module 512 is used by one or more communication device 400 to communicate with the charger assembly 200 via the communication network 1000. A control module 514 is able to initiate triggers for controls based on information received from the charger assembly 200 and can send these controls to the charger assembly 200 through the communication module 506 and across the communications device 1000 using the receiver/transceiver 512. For example, the control module 514 compares the status information received from the charger assembly 200 to pre-defined status information values (e.g. pre-defined charge levels for the batteries, pre-defined operation and status of the charger assembly, pre-defined cycle time of charger assembly, pre-defined health monitoring status related to the battery and charger, pre-defined responses to tampering and other operational alerts). The control module 514 is then configured to generate controls responses to the charging assembly based on the comparison.

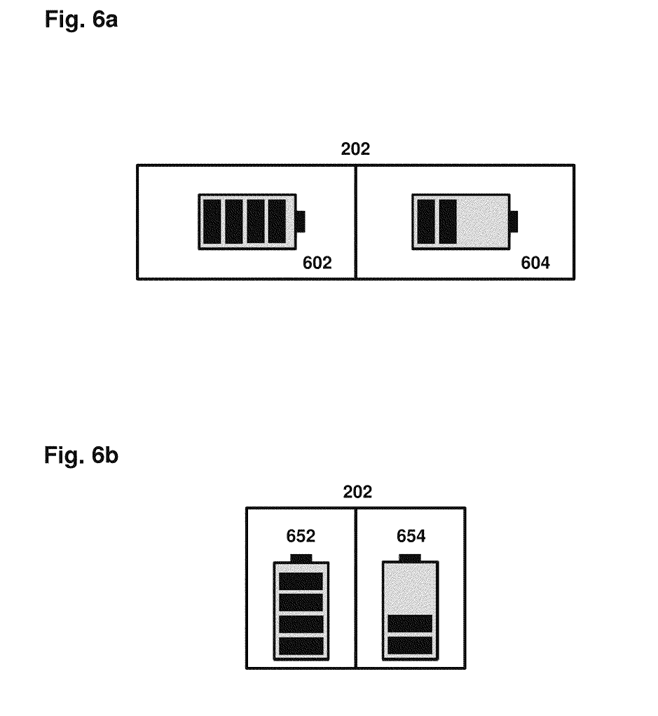

FIG. 6a illustrates an exemplary embodiment of the display 202 for visually indicating charge status of one or more batteries 210 (see FIG. 1) according to visual voltage levels or thresholds (e.g. on an LCD display). A display 602 displays one battery in a horizontal orientation, displaying an exemplary state where it is in a fully charged state. The state of the charge is indicated by the number of bars present in the image of the battery. A display 604 displays a second battery in a horizontal orientation, displaying the exemplary state of being half charged.

FIG. 6b illustrates an exemplary embodiment of the display 202. A display 652 displays one battery in a vertical orientation, displaying an exemplary state where it is in a fully charged state. The state of the charge is indicated by the number of bars present in the image of the battery. A display 654 displays a second battery in a vertical orientation, displaying the exemplary state of being half charged.

Exemplary threshold for each threshold voltages for each bar for a battery under charge is provided below. An example battery of 1.7v is used for the description below.
0v to 1.05V=no bar
1.06v to 1.25v=one bar
1.26v to 1.45v=two bars
1.46v to 1.63v=three bars
1.63v to 1.7v=four bars

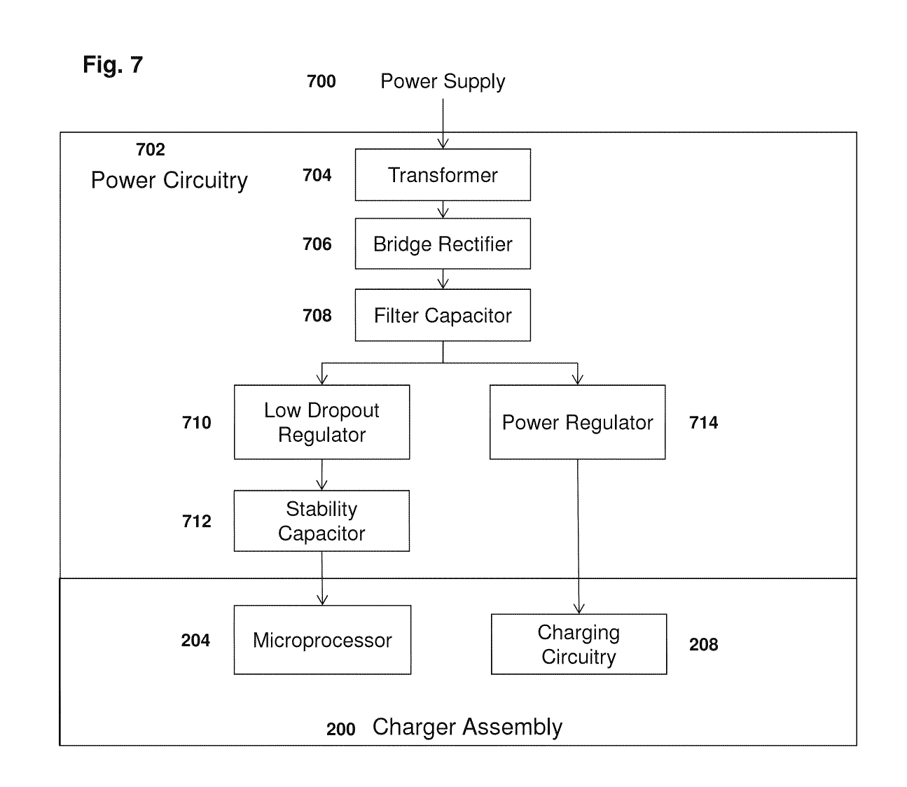

FIG. 7 depicts an exemplary embodiment of power circuitry 702 for the charger assembly 200. A power supply 700 in the form of outlet power or stored battery power is supplied to a transformer 704. The transformer 704 reduces the voltage of the supplied power to the amount needed for the power circuitry. A bridge rectifier 706 can be used to convert the supplied AC power to DC power needed by the electrical components of the charger assembly 200. A main filter capacitor 708 further filters the direct voltage from the main bridge rectifier 706 in order to stabilize it. The power is now divided into a separate supply for the microprocessor 204 and components for the charger assembly 200, and a separate supply for the charging circuitry 208. The supply for the microprocessor 204 and components for the charger assembly 200 has a low dropout regulator 710 to ensure the voltage is maintained at the minimum required for the microprocessor 204 and charger assembly 200 components. In one aspect, the charger assembly further includes components for filtering noise interferences (e.g. RC low pass filters) affect the voltage reading circuitry (e.g. module 304). Such filtering may be performed using digital averaging algorithms. A stability capacitor 712 is used to stabilize the output of the low dropout regulator 710 before it goes to the microprocessor 204 and charger assembly 200 components. Exemplary components for include the display 202 and receiver/transceiver 212 as shown in FIG. 2. The charging circuitry 208 is used to charge the batteries 210 and has a power regulator 714 to ensure the amount of voltage supplied to the charging circuitry is constant for the batteries 210 as shown in FIG. 2.

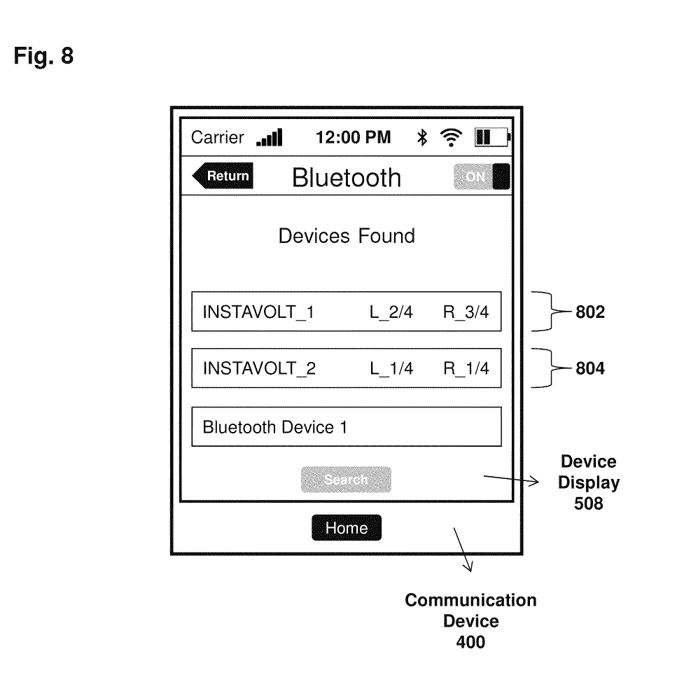

FIG. 8 describes an exemplary communication device 400 in the form of a cellular device referring to FIG. 1. The communication device 400 has a display 508 to display information received from the charger assembly 200 (e.g. 200 in FIG. 1). In this example, Bluetooth discovery communication is shown with the example of unidirectional communication with more than one charger assembly 200. In this exemplary embodiment, the communication device 400 is able to see the information broadcasted from the charger assembly 200 as the name or identifier of Bluetooth devices 802 and 804. The information displayed in this example is the name of the charger assembly 200 and the charge level of two batteries 210 in the charger assembly 200. As will be envisioned, any of the data packet 102 information (e.g. FIG. 1) could be communicated in this manner and masked as the Bluetooth identifier for the charger assembly 200. Exemplary text to designate battery charge status is mentioned below.
INSTAVOLT L_{—}2/4 R_{—}3/4 means left battery has 2 bars, right battery has 4 bars
INSTAVOLT L_none R_{—}3/4 means no left battery, right battery has 3 bars
INSTAVOLT L_low R_{—}1/4 means left battery is too low or defective, right battery has 1 bar
INSTAVOLT L_{—}4/4 R_{—}4/4 means both batteries are recharged

Exemplary embodiments of communication network technologies for communication network 1000 shown in FIG. 1 are discussed below. The wireless communication network 1000 can comprise of one or more of the technologies described below and may be dependent upon the capabilities of the charger assembly 200 shown in FIG. 1 and/or the communications device 400. In another embodiment, the monitoring system may be programmable to define which modes to communicate in (e.g. Bluetooth, Wi-Fi, etc.)

### Bluetooth

In one embodiment of the communication system 100 shown in FIG. 1, Bluetooth is used as the technology for the communication network 1000 to enable communication between the charger assembly 200 and one or more communications device 400. One exemplary embodiment can comprise unidirectional communication, conversely another exemplary embodiment can comprise of bidirectional communication.

In the exemplary embodiment of unidirectional communication, the charger assembly 200 is configured to communicate information related to the batteries 210 and/or information relating to the charger assembly 200 (e.g. data packets 102) across the communication network 1000 to one or more communication devices 400. The information related to the batteries 210 and/or information relating to the charger assembly 200 (e.g. data packets 102) is received by the communication device 400 through the receiver/transceiver 512 as shown. The received information (e.g. data packets 102) can then be displayed on the display 508 of the communication device as shown in FIG. 5. In one exemplary embodiment of unidirectional Bluetooth communication technology, the information related to the batteries 210 received by the communication device 400 though the communication network 1000 is displayed as the name of a Bluetooth device on the display 504, an exemplary embodiment is shown in FIG. 8.

In the exemplary embodiment of bidirectional communication, the charger assembly 200 is able to communicate information related to the batteries 210 and/or information relating to the charger assembly 200 (e.g. data packets 102) across the communication network 1000 to the communication device 400. The information related to the batteries 210 and/or information relating to the charger assembly 200 (e.g. data packets 102) is received by the communication device 400 through the receiver/transceiver 512 (shown in FIG. 5). The received information (e.g. data packets 102) can then be displayed on the display 508 (shown in FIG. 5). In this exemplary embodiment, the communication device 400 can be configured for communication with the charger assembly 200 and is able to provide control commands (e.g. response packets 104) initiated from the controls module 514 (shown in FIG. 5) to the charger assembly 200. The communication device 400 transmits control or inquiry commands (e.g. response packets 104) through the receiver/transceiver 512 (e.g. shown in FIG. 5), across the communication network 1000 to the charger assembly 200. The charger assembly 200 is able to receive these commands (e.g. response packets 104) through its receiver/transceiver 212 (shown in FIG. 2) and make the desired updates and/or controls to the charger assembly 200 and its components.

### Wi-Fi

In one embodiment of the communication system 100 shown in FIG. 1, Wi-Fi can be used as the technology for the communication network 1000 to enable communication between the charger assembly 200 and one or more communications device 400. This technology has bidirectional communication between the charger assembly 200 and one or more communication devices 400 across the communication network 1000. The charger assembly 200 is able to communicate information related to the batteries 210 and/or information relating to the charger assembly 200 (e.g. data packets 102) across the communication network 1000 to one or more communication device 400. The information related to the batteries 210 and/or information relating to the charger assembly 200 (e.g. data packets 102) is received by one or more communication devices 400 through the receiver/transceiver 512 (shown in FIG. 5). The received information (e.g. data packets 102) can then be displayed on the display 508 (shown in FIG. 5). In this exemplary embodiment, the communication device 400 can be configured for communication with the charger assembly 200 and is able to provide control commands (e.g. response packets 104) initiated from the controls module 514 (shown in FIG. 5) to the charger assembly 200. The communication device 400 transmits control or inquiry commands (e.g. response packets 104) through the receiver/transceiver 512 (shown in FIG. 5), across the communication network 1000, to the charger assembly 200. The charger assembly 200 is able to receive these commands (e.g. response packets 104) through its receiver/transceiver 212 (shown in FIG. 2) and make the desired updates and/or controls to the charger assembly 200 and its components.

### Radio Frequency

In one embodiment of the communication system 100 shown in FIG. 1, Radio Frequency can be used as the technology for the communication network 1000 to enable communication between the charger assembly 200 and one or more communications device 400. One exemplary embodiment can comprise unidirectional communication, conversely another exemplary embodiment can comprise of bidirectional communication.

In the exemplary embodiment of unidirectional communication, the charger assembly 200 is able to communicate information related to the batteries 210 and/or information relating to the charger assembly 200 (e.g. data packets 102) across the communication network 1000 to one or more communication devices 400. The information related to the batteries 210 and/or information relating to the charger assembly 200 (e.g. data packets 102) is received by the communication device 400 through the receiver/transceiver 512 (shown in FIG. 5) as shown. The received information (e.g. data packets 102) can then be displayed on the display 508 present on the communication device as shown in FIG. 5.

In the exemplary embodiment of bidirectional communication, the charger assembly 200 is able to communicate information related to the batteries 210 and/or information relating to the charger assembly 200 (e.g. data packets 102) across the communication network 1000 to the communication device 400. The information related to the batteries 210 and/or information relating to the charger assembly 200 (e.g. data packets 102) is received by the communication device 400 through the receiver/transceiver 512 (shown in FIG. 5). The received information (e.g. data packets 102) can then be displayed on the display 508 (shown in FIG. 5). In this exemplary embodiment, the communication device 400 can be configured for communication with the charger assembly 200 and is able to provide control commands (e.g. response packets 104) initiated from the controls module 514 (shown in FIG. 5) to the charger assembly 200. The communication device 400 transmits control or inquiry commands (e.g. response packets 104) through the receiver/transceiver 512 (shown in FIG. 5), across the communication network 1000, to the charger assembly 200. The charger assembly 200 is then configured to receive these commands (e.g. response packets 104) through its receiver/transceiver 212 (shown in FIG. 2) and implement the desired updates and/or controls to the charger assembly 200 and control or monitor the functionality of its components.

While particular embodiments of the present invention have been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiments.

1. A method for communicating with a battery charging assembly at an external communication device across a communication network, the method comprising:
receiving status information relating to the battery charging assembly at the communication device;
generating an input at the communication device in response to the status information, the input indicating a request for controlling operation of the battery charging assembly and comprising control parameters associated with controlling said operation;
providing the input to the battery charging assembly for subsequently affecting operation of the battery charging assembly in accordance with the input.

2. The method of claim 1, further comprising displaying the status information on a display of the communication device, the status information visually indicating a level of charge for each battery in the charging assembly with respect to at least one pre-defined threshold level.

3. The method of claim 1, further comprising generating the input further in response to receiving user input at a user interface of the communication device in response to the status information.

4. A method for communicating between a battery charging assembly and an external communication device across a communication network, the method comprising:
detecting a charge status of at least one battery charging in the battery charging assembly, the charge status indicating a level of charge of the at least one battery; and
providing status information indicating the charge status of the at least one battery from the battery charging assembly to the external communication device,
wherein providing the status information comprises masking the status information within connection information broadcast from the battery charging assembly to the external communication device.

5. The method of claim 4, wherein the connection information comprises Bluetooth connectivity information.

6. The method of claim 4, further comprising displaying the status information on an LCD display of the battery charging assembly, wherein the status information displays the level of charge of the at least one battery with a plurality of indicator bars, each indicator bar corresponding to a voltage threshold level, each indicator bar for visually displaying when a corresponding voltage threshold is met.

7. The method of claim 4, wherein communicating between the battery charging assembly and the external communication device comprises using one of Bluetooth and Wi-Fi communication.

8. The method of claim 5, wherein the external communication device communicates with the battery charging assembly via Bluetooth and further comprising displaying the status information for separately providing the charge status indicating a level of charge for each battery on the external communication device within Bluetooth discovery parameters associated with discovering and identifying the battery charging assembly.

9. The method of claim 8, wherein the status information displayed on the external communication device comprises at least one of: health information related to each battery of the charging assembly; health monitoring information for charging circuitry of the charging assembly; alerts indicating tampering during charging activity of the charging assembly; and
charging assembly operational status.

10. The method of claim 3, further comprising receiving updated status information from the battery charging assembly for display at the external communication device, the updated status information indicating the operation of the charging assembly subsequent to implement the control parameters on the charging assembly.

11. The method of claim 10, wherein the control parameters comprise a request for at least one of:
starting or stopping charging of the at least one battery in the charging assembly; and,
starting or stopping charging of the charging assembly, the request for subsequent implementation and acknowledgement from the charging assembly.

12. The method of claim 2, wherein the display comprises an LCD display for visually displaying a plurality of bars, each bar indicating that a pre-defined threshold voltage is met by an associated battery being charged.

13. The method of claim 1, wherein the input indicating the request for controlling operation of the battery charging assembly further comprises a request for receiving a status update relating to one or more batteries associated with the battery charging assembly.

14. The method of claim 8, wherein the battery charging assembly broadcasts charge status information indicating charge levels for associated batteries being charged to associated communication devices via Bluetooth identification mechanism, the Bluetooth identification mechanism identifying the battery charging assembly and associated charge status information.

15. The method of claim 1, wherein generating an input further comprises: processing the status information at the external communication device; comparing status information to pre-defined threshold values for the status information defined for the battery charging assembly; generating the input at the communication device in response to the comparison, the input for controlling operation of the battery charging assembly according to said pre-defined threshold values.

16. The method of claim 15, wherein generating the input comprises comparing at least one of: charge levels for each associated battery; health information values for the battery charger assembly; tampering alert values for the battery charger assembly to at least one of: pre-defined threshold values and health information values for the battery charger assembly and respective batteries.

17. The method of claim 1, wherein the generated input comprises one of: a request for starting or stopping a charging of at least one battery in the battery charging assembly for subsequent implementation at a control unit of the battery charging assembly coupled to said at least one battery.
